(19) United States
(12) Patent Application Publication
(10) Pub. No.: US 2026/0296279 A1
(43) Pub. Date: Oct. 1, 2026

(54) MOBILE BODY

(71) Applicant: HONDA MOTOR CO., LTD., Tokyo (JP)

(72) Inventors: Daisuke NOHARA, Saitama (JP); Masaki GOTO, Saitama (JP); Tomokazu SAKAMOTO, Saitama (JP)

(21) Appl. No.: 19/529,693

(22) Filed: Feb. 4, 2026

(30) Foreign Application Priority Data
Mar. 31, 2025 (JP) 2025-059791

(51) Int. Cl. B60N 2/68; B60N 2/02; B60N 2/30

(52) U.S. Cl. CPC B60N 2/682; B60N 2/02246; B60N 2/3013

(57) ABSTRACT

A mobile body includes: a lower unit provided with a drive unit; an upper unit disposed above the lower unit; and a lift device for raising and lowering the upper unit relative to the lower unit between a low position and a high position. The upper unit includes: a seat supported on the lift device; a leg part provided to be movable in an up-down direction and capable of contacting a ground; an electric actuator configured to generate a driving force for moving the leg part in the up-down direction; and a control device configured to control the lift device. As seen from above, the lift device is disposed at a center of the seat, and the electric actuator and the control device are disposed on opposite sides from each other with respect to the lift device.

### TECHNICAL FIELD

The present invention relates to a mobile body.

### BACKGROUND ART

Conventionally, an inverted pendulum mobile body as disclosed in JP2023-115571A is known. The mobile body includes a lower unit provided with a drive unit movable on a floor surface, an upper unit disposed above the lower unit, and a lift device provided between the lower unit and the upper unit to raise and lower the upper unit between a low position and a high position. The upper unit includes a seat and a leg part extending downward from the seat and to be movable in the up-down direction relative to the seat and capable of contacting the floor surface (ground). The leg part is connected to an operation lever via a transmission mechanism. Depending on an operation of the lever by the occupant, the leg part is displaced in the up-down direction to contact the floor surface or to be separated upward from the floor surface.

To improve the operability, it is conceived to drive the leg part with an electric actuator. However, since the electric actuator has a relatively large weight, there is a possibility that the position of the center of gravity of the upper unit may deviate and the posture of the mobile body may change. Particularly, in a mobile body that uses inverted pendulum control, this deviation of the center of gravity may affect the stability of the posture.

### SUMMARY OF THE INVENTION

In view of the foregoing background, an object of one aspect of the present invention is to provide a mobile body in which the electric actuator for driving the leg part is disposed to achieve good balance.

To achieve the above object, one aspect of the present invention provides a mobile body, comprising: a lower unit provided with a drive unit; an upper unit disposed above the lower unit; and a lift device for raising and lowering the upper unit relative to the lower unit between a low position and a high position, wherein the upper unit comprises: a seat supported on the lift device; a leg part provided to be movable in an up-down direction and capable of contacting a ground; an electric actuator configured to generate a driving force for moving the leg part in the up-down direction; and a control device configured to control the lift device, and wherein as seen from above, the lift device is disposed at a center of the seat and the electric actuator, and the control device are disposed on opposite sides from each other with respect to the lift device.

According to the above aspect, a mobile body in which the electric actuator for driving the leg part to achieve good balance can be provided.

### BRIEF DESCRIPTION OF THE DRAWINGS

FIG. 1 is a perspective view of a mobile body according to an embodiment (with a pad unit, upper cowls, and lower cowls being omitted);

FIG. 2 is a sectional view of the mobile body when an upper unit is in a low position;

FIG. 3 is a sectional view of a friction driving device;

FIG. 4 is an explanatory diagram of a lift device;

FIG. 5 is a sectional view of the mobile body when the upper unit is in a high position;

FIG. 6 is a plan view of the upper unit (with the pad unit being omitted);

FIG. 7 is a left side view of the upper unit (with the pad unit being omitted);

FIG. 8 is a right side view of the upper unit (with the pad unit being omitted);

FIG. 9 is a perspective view of a main part of the upper unit;

FIG. 10 is an explanatory diagram showing a coupling mechanism when a lock member is in a release position;

FIG. 11 is an explanatory diagram showing the coupling mechanism when the lock member is in a lock position;

FIG. 12 is a perspective view of an upper portion of the mobile body;

FIG. 13 is a sectional view of a mobile body according to a modification;

FIG. 14 is a sectional view of the mobile body according to the modification when the upper unit is in a low position; and

FIG. 15 is a sectional view of the mobile body according to the modification when the upper unit is in a high position.

### DETAILED DESCRIPTION OF THE INVENTION

In the following, an embodiment of a mobile body will be described with reference to the drawings. In the present embodiment, the mobile body is configured as an inverted pendulum vehicle.

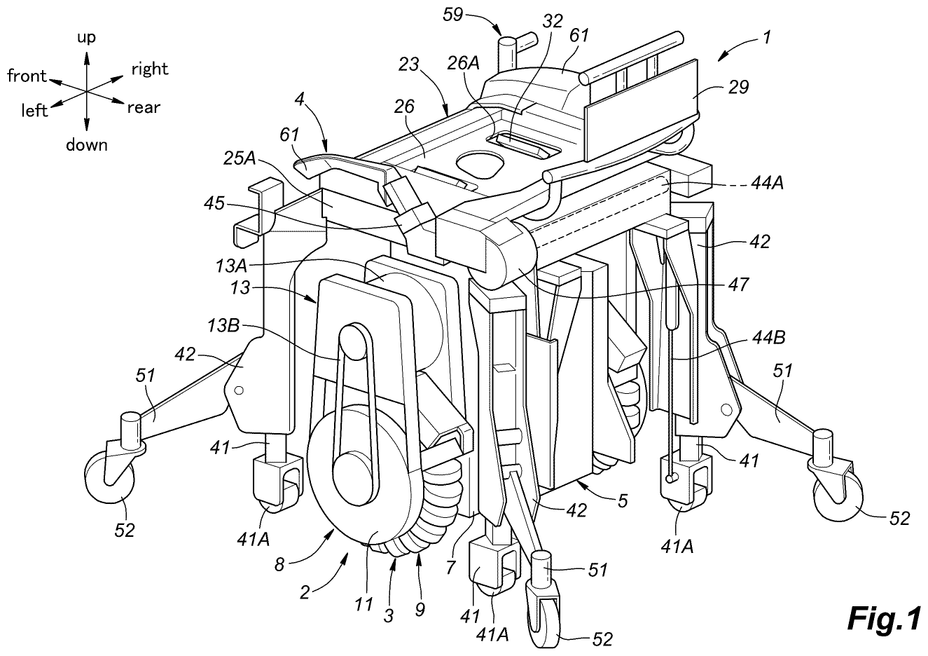

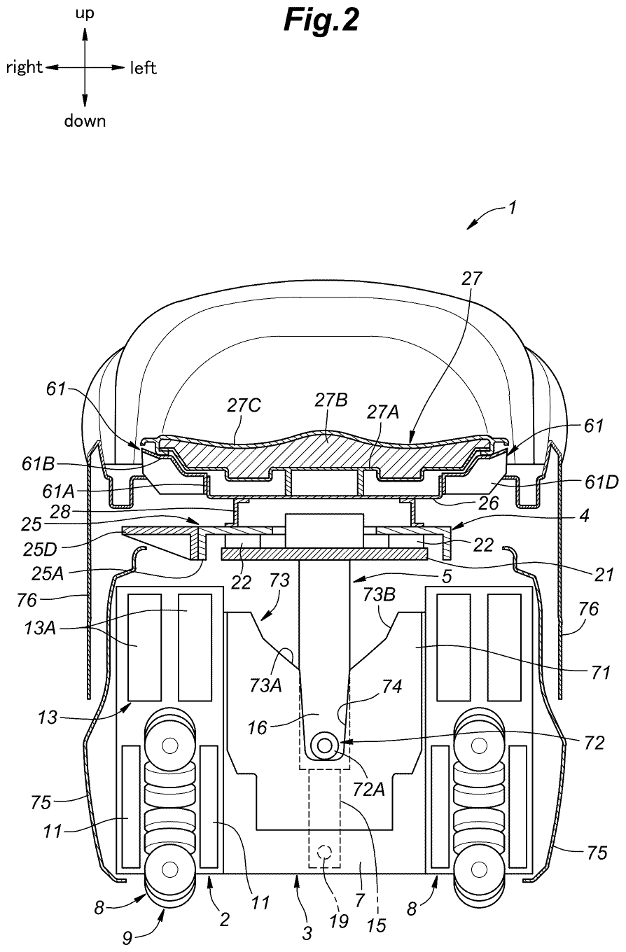

As shown in FIG. 1 and FIG. 2, a mobile body 1 includes a lower unit 3 provided with a drive unit 2 movable on a floor surface, an upper unit 4 disposed above the lower unit 3, and a lift device 5 for raising and lowering the upper unit 4 relative to the lower unit 3 between a low position and a high position.

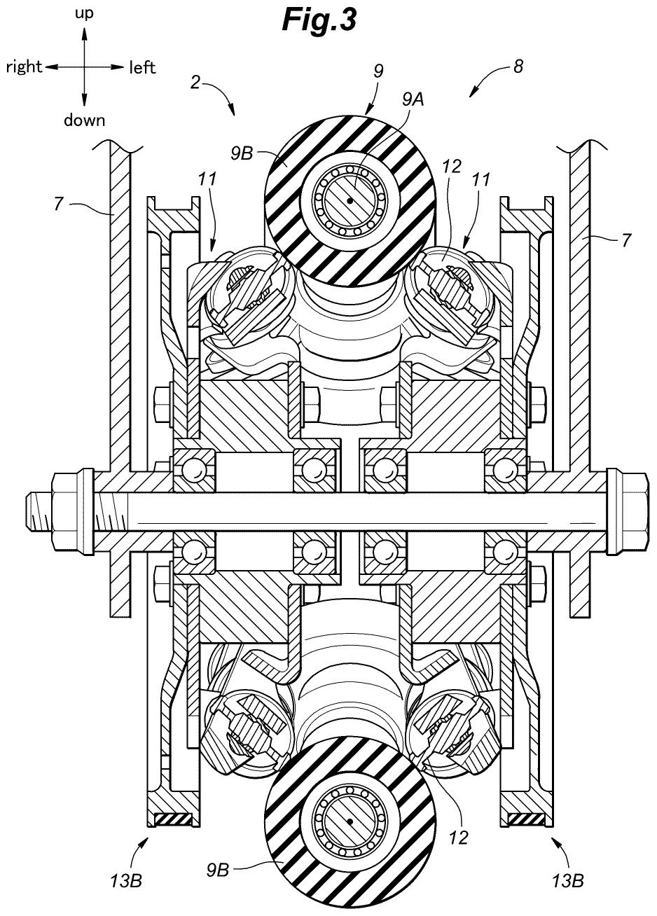

The lower unit 3 includes a vehicle body frame 7 that supports the drive unit 2. The drive unit 2 includes a pair of left and right friction driving devices 8 provided on left and right side portions of the vehicle body frame 7. Each friction driving device 8 includes a drive wheel 9 that is driven under the inverted pendulum control. As shown in FIG. 3, the friction driving device 8 includes a pair of left and right drive disks 11 rotatably supported on the vehicle body frame 7, multiple drive rollers 12 rotatably supported on each of the drive disks 11, an annular drive wheel 9 disposed between the left and right drive disks 11 to be in contact with the drive rollers 12, and a pair of electric actuators 13 for individually rotating the respective drive disks 11. The pair of drive disks 11 are disposed to be coaxial with each other, and their rotation axes extend in the left-right direction. As shown in FIG. 1 to FIG. 3, each electric actuator 13 includes an electric motor 13A and a transmission mechanism 13B for transmitting the rotational force of the electric motor 13A to the corresponding drive disk 11. The transmission mechanism 13B is preferably a belt transmission mechanism, for example. The electric motor 13A is preferably disposed above the drive disk 11.

As shown in FIG. 3, the drive wheel 9 is annular in shape and is disposed between the pair of drive disks 11 to be coaxial with the drive disks 11. Also, the drive wheel 9 is in contact with the multiple drive rollers 12 and is rotatable about a central axis and about an annular axis. The drive wheel 9 includes a core 9A having a circular annular shape and multiple driven rollers 9B rotatably supported by the core 9A, for example. Each driven roller 9B is supported by the core 9A to be rotatable about an annular axis of the core 9A. Each driven roller 9B receives a load from the drive disks 11 and rotates relative to the core 9A.

When the pair of drive disks 11 are turned in the same direction at the same rotation speed, the drive wheel 9 rotates in the same direction and at the same rotation speed as the drive disks 11. When there is a difference in the rotation direction or the rotation speed between the pair of drive disks 11, the driven rollers 9B of the drive wheel 9 rotate relative to the core 9A. As a result, the friction driving device 8 can generate a lateral propulsion force relative to the floor surface.

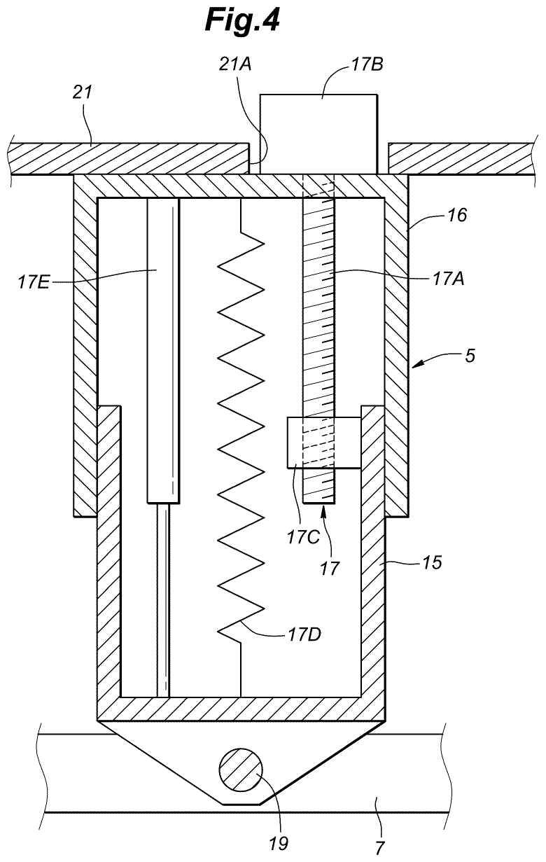

The lift device 5 raises and lowers the upper unit 4 between a low position and a high position. As shown in FIG. 4, the lift device 5 includes a lower member 15 tiltably provided on the lower unit 3 and an upper member 16 supported to be movable up and down relative to the lower member 15 and joined to the upper unit 4. Each of the lower member 15 and the upper member 16 is preferably formed in a tubular shape extending in the up-down direction, for example. The lower member 15 is slidably inserted into an inside of the upper member 16. Inside the upper member 16 and the lower member 15, an expansion and contraction mechanism 17 for moving the upper member 16 relative to the lower member 15 is provided. The expansion and contraction mechanism 17 is preferably a screw mechanism, for example. The screw mechanism includes a screw shaft 17A extending vertically and rotatably supported by the upper member 16, an electric motor 17B provided on the upper end of the upper member 16 to rotate the screw shaft 17A, and a nut 17C provided on the lower member 15 and threadedly engaged with the screw shaft 17A. Thereby, when the screw shaft 17A is rotated by the electric motor 17B, the upper member 16 moves upward or downward relative to the lower member 15. Namely, the lift device 5 expands or contracts in the up-down direction. The expansion and contraction mechanism 17 may be a rack-and-pinion mechanism, a linear motor, or an air cylinder that is caused to expand and contract by compressed air. Inside the upper member 16 and the lower member 15, a spring 17D for urging the lower member 15 and the upper member 16 toward each other and a damper 17E for damping the movement of the upper member 16 relative to the lower member 15 may be further provided. The damper 17E is preferably a cylinder damper.

The lower member 15 is provided on the lower unit 3 to be tiltable about a tilt shaft 19 extending in the front-rear direction. Preferably, the lower member 15 is pivotably supported on the tilt shaft 19 provided in the vehicle body frame 7 to extend in the front-rear direction. The angle of the lift device 5 relative to the lower unit 3 about the tilt shaft 19 is referred to as a tilt angle. The tilt angle is an angle in the plane perpendicular to the tilt shaft 19. In a state in which the tilt shaft 19 extends in the horizontal direction, the tilt angle when the axis of the lift device 5 extends in the vertical direction is defined as an initial angle (0 degrees). In another embodiment, the extension direction of the tilt shaft 19 may be changed arbitrarily. For example, the tilt shaft 19 may extend in the front-rear direction.

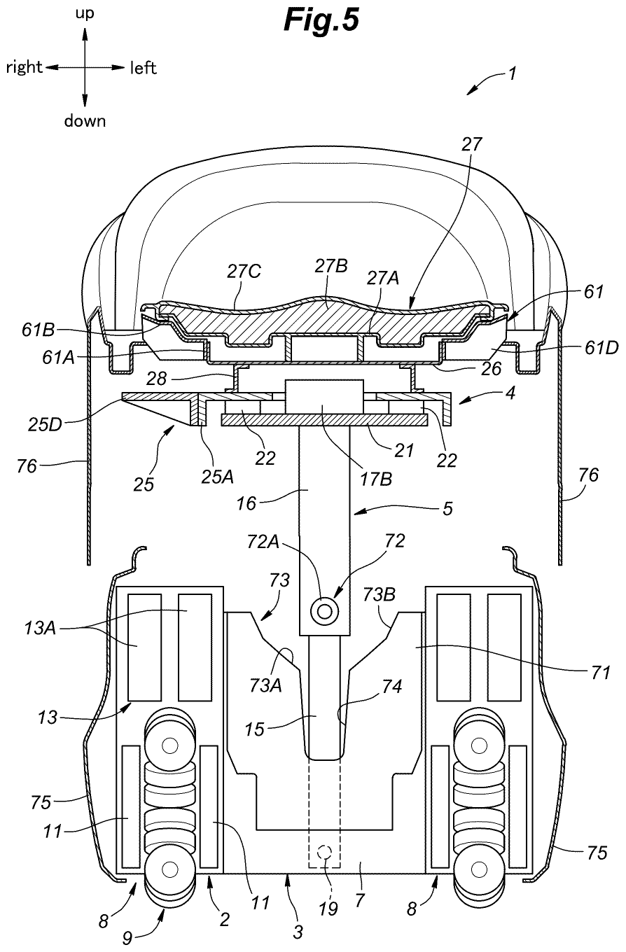

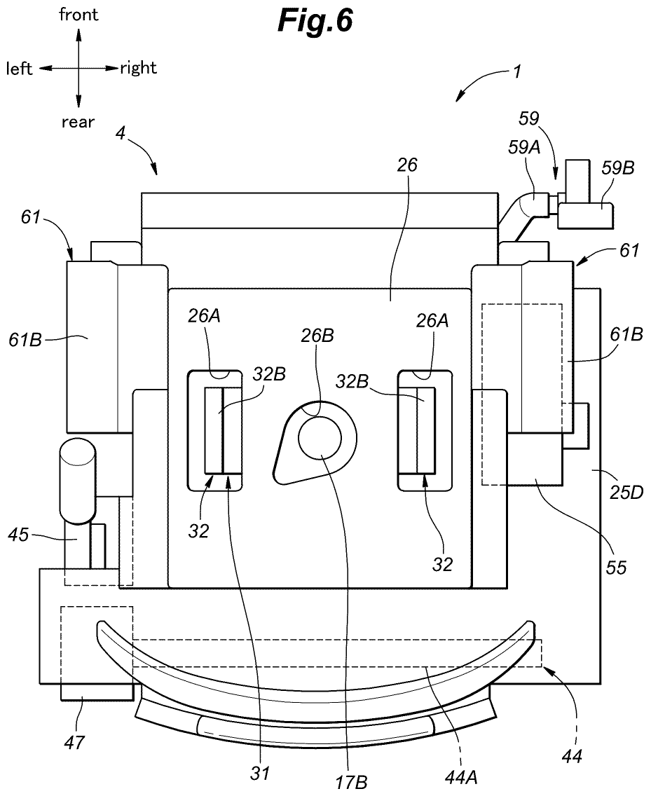

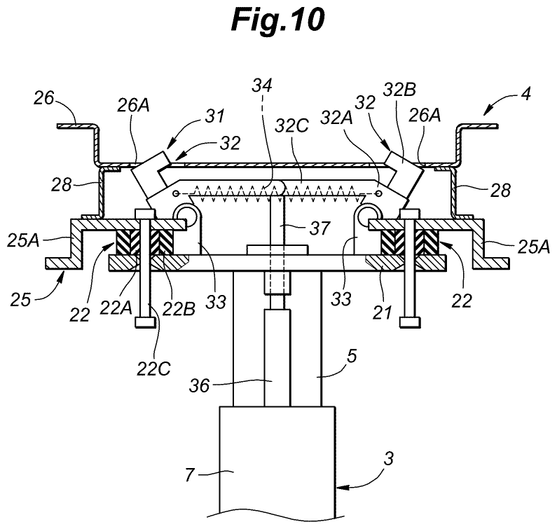

As shown in FIG. 2, FIG. 5, and FIG. 6, the upper unit 4 includes a base part 21 joined to the lift device 5 and a seat 23 supported on the base part 21 via elastic members 22 to support the buttocks of the occupant. The base part 21 is formed in a plate shape and is joined to the upper end of the upper member 16. The base part 21 is provided with an opening that passes through it vertically. In the opening, the electric motor 17B of the lift device 5 is disposed. The elastic members 22 are provided on the upper surface of the base part 21. The elastic members 22 may be made of rubber, for example. Each elastic member 22 is preferably formed in a cylindrical shape extending vertically. The elastic member 22 may be formed of multiple materials having different elastic moduli. As shown in FIG. 10, for example, the material forming a central part 22A of the elastic member 22 preferably has a higher elastic modulus than the material forming an outer peripheral part 22B of the elastic member 22. These materials are preferably disposed in concentric circles. To prevent the elastic member 22 from tilting, the elastic member 22 may be provided with a support shaft 22C at the center thereof so as to pass therethrough in the up-down direction. Preferably, the support shaft 22C passes through the base part 21, the elastic member 22, and the seat 23 in the up-down direction and is supported to be displaceable in the up-down direction relative to them.

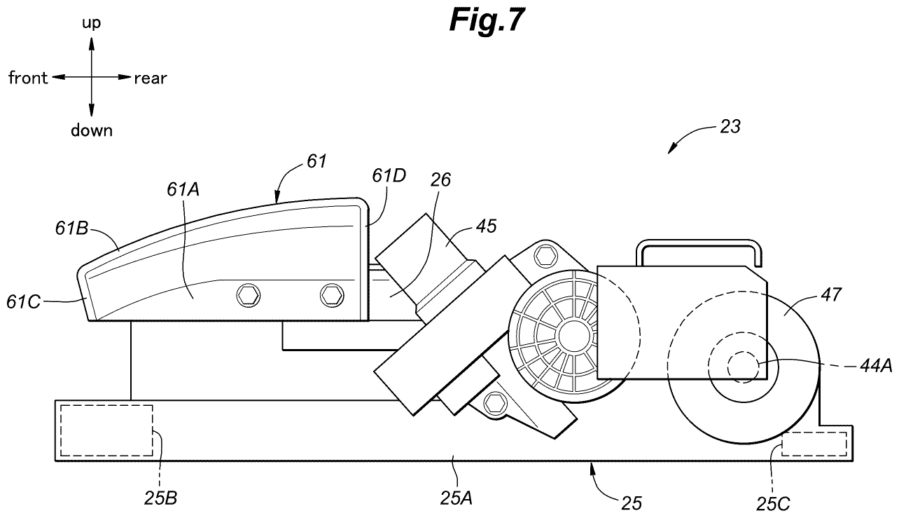

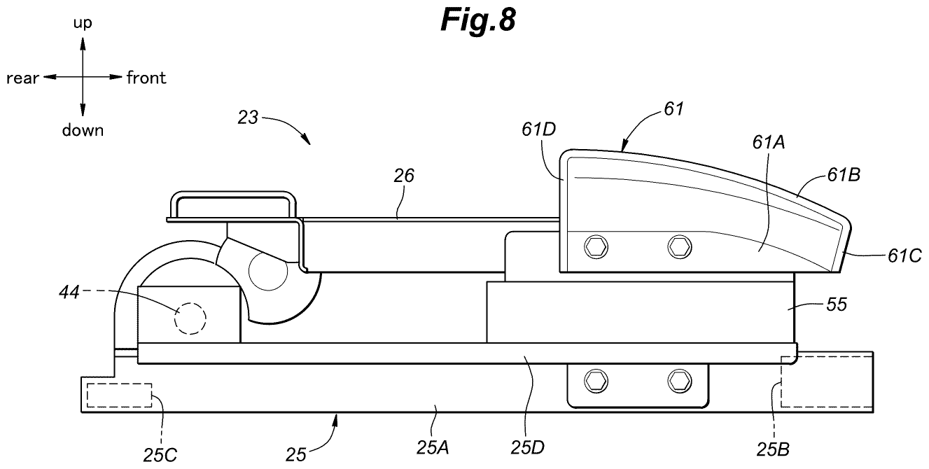

As shown in FIG. 2, the seat 23 includes a seat frame 25, a seat plate 26 joined to the seat frame 25, and a pad unit 27 supported on the seat plate 26. The seat frame 25 is formed in a frame shape. As shown in FIG. 2, FIG. 7, and FIG. 8, the seat frame 25 preferably includes left and right side members 25A extending in the front-rear direction, a front member 25B extending laterally and joined to the front ends of the left and right side members 25A, and a rear member 25C extending laterally and joined to the rear ends of the left and right side members 25A. The right side member 25A is preferably provided with an extension member 25D that protrudes rightward. The extension member 25D extends in the front-rear direction along the right side member 25A.

The seat frame 25 is placed on the base part 21 via the elastic members 22. The seat plate 26 is formed in a plate shape with surfaces facing up and down, and is joined to the upper portion of the seat frame 25 via multiple stays 28. The seat plate 26 is disposed above the upper surface of the seat frame 25 via a gap. A backrest frame 29 that extends upward may be provided on the rear portion of the seat plate 26.

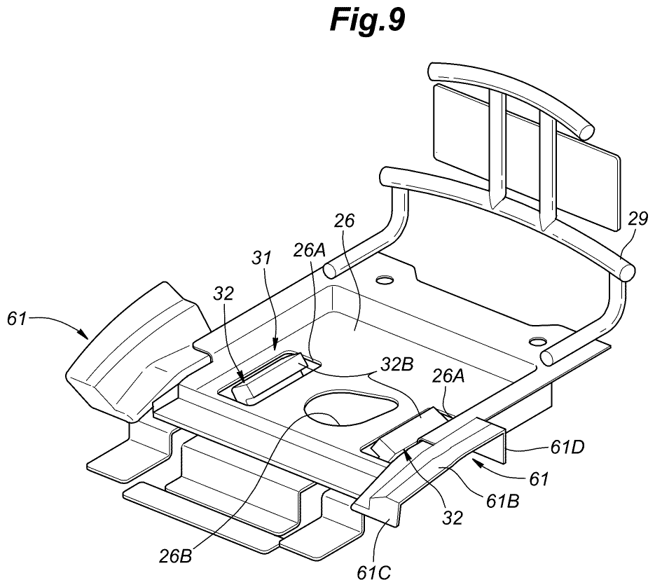

As shown in FIG. 9, the mobile body 1 includes a coupling mechanism 31 that selectively couples the base part 21 and the seat 23. The coupling mechanism 31 couples the base part 21 and the seat 23 so that the seat 23 cannot move relative to the base part 21 (fixed state) when the upper unit 4 is in the high position, and decouples the seat 23 from the base part 21 so that the seat 23 can move relative to the base part 21 (elastic state) when the upper unit 4 is in the low position.

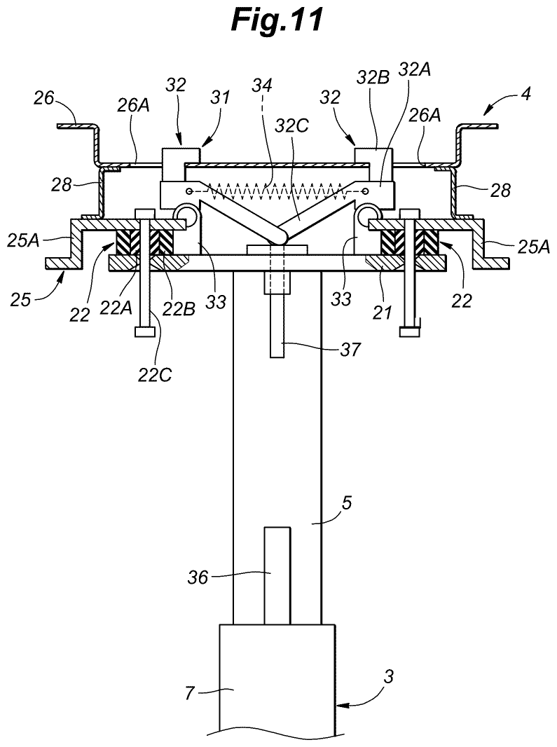

As shown in FIG. 9, FIG. 10, and FIG. 11, the coupling mechanism 31 includes a pair of lock members 32 provided on the base part 21 to be displaceable between a release position and a lock position and capable of clamping the seat 23. The pair of lock members 32 are provided on a pair of support parts 33 provided on the base part 21. The pair of support parts 33 protrude upward from the upper surface of the base part 21. The pair of support parts 33 are disposed on the left and right of the opening. Each lock member 32 includes a main body 32A pivotably supported by the corresponding support part 33, a hook part 32B protruding upward from the main body 32A, and a lever part 32C that extends from the main body 32A toward the center of the base part 21. The hook part 32B is preferably formed in an L shape, for example. Due to pivoting of the main body 32A relative to the support part 33, the lock member 32 is displaced between the release position and the lock position.

As shown in FIG. 11, when the lock members 32 are in the lock position, each of the hook parts 32B extends upward from the corresponding main body 32A. Also, the tips of the hook parts 32B extend toward each other. When the lock members 32 are in the lock position, the lever parts 32C extend from the corresponding main bodies 32A obliquely downward toward each other. The tips of the lever parts 32C are disposed close to each other at the center of the base part 21 in the left-right direction.

As shown in FIG. 10, when the lock members 32 are in the release position, each hook part 32B extends from the corresponding main body 32A upward and laterally outward. Also, the lever parts 32C extend from the corresponding main bodies 32A laterally toward each other. When the lock members 32 move from the lock position to the release position, the tips of the lock members 32 move away from each other and the tips of the lever parts 32C move upward.

The coupling mechanism 31 includes an urging member 34 that urges the pair of lock members 32 toward the lock position. The urging member 34 is a tension coil spring, for example, and is stretched between the main bodies 32A of the pair of lock members 32.

As shown in FIG. 10, when the upper unit 4 is in the low position, the pair of lock members 32 is maintained in the release position by being pushed by a pressing part 36 provided on the lower unit 3. As shown in FIG. 11, as the upper unit 4 is raised toward the high position, the pair of lock members 32 are separated from the pressing part 36 and become able to move to the lock position. The pressing part 36 is preferably provided on the vehicle body frame 7 of the lower unit 3. Also, the pressing part 36 may be provided on the lower member 15 of the lift device 5. The pressing part 36 pushes the tips of the lever parts 32C of the pair of lock members 32 upward when the upper unit 4 is in the low position. In the present embodiment, the pressing part 36 pushes the tips of the lever parts 32C upward via an intermediate member 37. The intermediate member 37 is supported on the base part 21 to be displaceable in the up-down direction. The intermediate member 37 is preferably a rod extending vertically. The upper end of the intermediate member 37 contacts the tips of the lever parts 32C of the pair of lock members 32 from below. When the upper unit 4 is in the low position, the lower end of the intermediate member 37 contacts the upper end of the pressing part 36. The pair of lock members 32 are displaced from the release position to the lock position when the upper unit 4 moves from the low position to the high position. When the upper unit 4 moves from the low position toward the high position, the pair of lock members 32 are preferably maintained in the release position over a predetermined section from the low position. When the lower end of the intermediate member 37 is separated from the pressing part 36, the pair of lock members 32 are positioned in the lock position. The timing at which the pair of lock members 32 are switched from the release position to the lock position may be set arbitrarily. The timing at which the pair of lock members 32 are switched from the release position to the lock position can be preferably adjusted by changing the shape or position of the lever part 32C of each lock member 32, the intermediate member 37, and/or the pressing part 36, for example.

The seat plate 26 includes a pair of engagement holes 26A with which the pair of lock members 32 can engage. The pair of engagement holes 26A are provided to the left and right of a center hole 26B formed at the center of the seat plate 26. The hook parts 32B of the pair of lock members 32 protrude into the laterally corresponding engagement holes 26A. When the pair of lock members 32 are in the release position, the pair of hook parts 32B are separated from the edge parts of the corresponding engagement holes 26A. Namely, the pair of lock members 32 are separated from the seat plate 26. Therefore, the seat 23 can be displaced relative to the base part 21. When the pair of lock members 32 are in the lock position, the pair of hook parts 32B engage with the edge parts of the corresponding engagement holes 26A, and clamp the seat plate 26 from left and right. Therefore, the displacement of the seat 23 relative to the base part 21 is restricted, and the base part 21 and the seat 23 become united.

As shown in FIG. 1, the mobile body 1 includes at least one first leg part 41 provided on the seat 23 to be movable in the up-down direction and capable of contacting the ground. In the present embodiment, four first leg parts 41 are provided on the seat frame 25. At each of the four corners of the seat frame 25, a leg support part 42 that extends downward is provided. A front left leg support part 42 is provided at the joint between the front end of the left side member 25A and the left end of the front member 25B. A front right leg support part 42 is provided at the joint between the front end of the right side member 25A and the left end of the front member 25B. A rear left leg support part 42 is provided at the joint between the rear end of the left side member 25A and the left end of the rear member 25C. A rear right leg support part 42 is provided at the joint between the rear end of the right side member 25A and the right end of the rear member 25C. Each first leg part 41 has the same structure. Also, each leg support part 42 has the same structure.

The first leg parts 41 are joined to the seat frame 25 via the respective leg support parts 42. Each first leg part 41 extends in the up-down direction and is supported by the leg support part 42 to be displaceable in the up-down direction. The lower end of the first leg part 41 protrudes downward from the lower end of the leg support part 42. The first leg part 41 moves downward relative to the leg support part 42 due to the gravity. Between the first leg part 41 and the leg support part 42, a damper for damping the movement of the first leg part 41 may be provided. The damper is preferably an oil cylinder damper or an air cylinder damper. Between the first leg part 41 and the leg support part 42, a spring for urging the first leg part 41 downward relative to the leg support part 42 may be provided.

A contact member 41A is provided at the lower end of each first leg part 41. The contact member 41A preferably has a higher flexibility than the first leg part 41. Also, the contact member 41A preferably has a higher friction coefficient than the first leg part 41. The contact member 41A is preferably made of rubber or elastomer, for example. With the contact members 41A contacting the ground, the mobile body 1 is maintained in the stop state. Since the mobile body 1 is maintained in the stop state due to the friction force between each contact member 41A and the floor surface, it is unnecessary to supply electric power to the friction driving device 8 in order to maintain the mobile body 1 in the stop state, and thus, energy efficiency can be improved.

Each first leg part 41 is connected to an electric actuator 45 via a transmission mechanism 44. The electric actuator 45 is provided on the seat 23 and generates a driving force for moving each first leg part 41 in the up-down direction. In the present embodiment, the electric actuator 45 is an electric motor and is provided on the seat frame 25. Specifically, the electric actuator 45 is preferably joined to a rear portion of one of the left and right side members 25A. The transmission mechanism 44 preferably includes a lever 44A that rotates when receiving the driving force of the electric actuator 45 and multiple cables 44B connecting the lever 44A to the respective first leg parts 41. When the lever 44A is rotated in the normal direction by the electric actuator 45, each cable 44B is pulled by the lever 44A and each first leg part 41 is raised. When the lever 44A is rotated in the negative direction by the electric actuator 45, each cable 44B is loosened and each first leg part 41 is lowered. Preferably, the lever 44A extends in the left-right direction and is rotatably supported by the rear member 25C, for example.

When the upper unit 4 is in the low position and each first leg part 41 is not pulled up by the corresponding cable 44B, the contact part of each first leg part 41 contacts the ground. On the other hand, even when the upper unit 4 is in the low position, if each first leg part 41 is pulled up by the corresponding cable 44B, the contact part of each first leg part 41 does not contact the floor surface. Also, when the upper unit 4 is in the high position, the contact part of each first leg part 41 does not contact the floor surface even if each first leg part 41 is not pulled up by the corresponding cable 44B.

The electric actuator 45 preferably includes a holding mechanism 47 for holding the position of the leg parts with electric power. The holding mechanism 47 is preferably an electromagnetic brake or an electromagnetic clutch, for example. The holding mechanism 47 restricts the displacement of the first leg parts 41 when receiving electric power, and permits the displacement of the first leg parts 41 when not receiving electric power. Namely, when the holding mechanism 47 is not receiving electric power, each first leg part 41 can be lowered. Preferably, the holding mechanism 47 is provided at the end portion of the lever 44A to restrict the rotation of the lever 44A. In another embodiment, the holding mechanism 47 may be incorporated in the electric actuator 45.

Each of the leg support parts 42 is provided with a second leg part 51. Each second leg part 51 has the same configuration. The second leg part 51 is pivotably joined to the leg support part 42. The second leg part 51 is pivotable between a stowed position in which the second leg part 51 is disposed close to the vehicle body frame 7 and a deployed position in which the second leg part 51 is more separated from the vehicle body frame 7 to the side than in the stowed position.

The second leg part 51 is pivotably joined to the corresponding leg support part 42 at an upper end thereof. A roller 52 is rotatably attached to the lower end of the second leg part 51. The roller 52 is preferably a caster having a rotation shaft that rotates relative to the second leg part 51 about a vertical axis. In another embodiment, a ball may be supported at the lower end of the second leg part 51 instead of the roller 52.

The lower end of the front left second leg part 51 moves forward and leftward from the stowed position to the deployed position. The lower end of the front right second leg part 51 moves forward and rightward from the stowed position to the deployed position. The lower end of the rear left second leg part 51 moves rearward and leftward from the stowed position to the deployed position. The lower end of the rear right second leg part 51 moves rearward and rightward from the stowed position to the deployed position. The moving direction of each second leg part 51 from the stowed position to the deployed position may be changed as appropriate.

The second leg part 51 includes multiple stoppers for restricting the pivoting range. The stoppers are preferably provided at the connecting part between the leg support part 42 and the upper end of the second leg part 51.

The second leg part 51 includes an urging member (not shown in the drawings) that urges the second leg part 51 from the deployed position to the stowed position. Specifically, the urging member is preferably provided at the connecting part between the leg support part 42 and the upper end of the second leg part 51. The urging member is preferably a torsion spring, a tension coil spring, a compression coil spring, or the like. Each second leg part 51 is displaced from the stowed position to the deployed position when the roller 52 is pushed against the floor surface. Dampers (not shown in the drawings) may be provided at the connecting part between the leg support part 42 and the upper end of the second leg part 51 and at the connecting part between the lower end of the second leg part 51 and the upper end of the second leg part 51. The dampers are preferably a rotation damper, a piston damper, or the like.

When the upper unit 4 is in the high position, each roller 52 and each contact member 41A are separated from the floor surface. When the upper unit 4 is in the high position, the lower end of each contact member 41A is disposed lower than the lower end of each roller 52. When the upper unit 4 is in the low position, each roller 52 and each contact member 41A contact the floor surface. When the upper unit 4 moves from the high position to the low position, each contact member 41A comes into contact with the floor surface earlier than each roller 52 does. Thereby, when the upper unit 4 moves to the low position, the mobile body 1 can be brought to the stop state early.

Since each first leg part 41 is supported to be movable in the up-down direction, each contact member 41A can reliably contact the floor surface. Each second leg part 51 moves from the stowed position to the deployed position by being pushed against the floor surface. Thereby, the distance between the ground contact points of the second leg parts 51 widens, and the posture of the mobile body 1 in the low position becomes stable.

As shown in FIG. 6 and FIG. 8, the mobile body 1 includes a control device 55. The control device 55 is a computer including a processor and a memory communicatively connected to the processor. The processor preferably includes, as a core, at least one of a CPU (Central processing Unit), a GPU (Graphics Processing Unit), and a RISC (Reduced Instruction Set Computer), for example. The memory stores a control program executed by the processor and various data. The processor implements various applications by executing the program stored in the memory. The control device 55 preferably includes a case having a flat rectangular cuboid shape.

The control device 55 is provided on the seat 23. Specifically, the control device 55 is preferably mounted to the seat frame 25 of the seat 23. The control device 55 controls at least the lift device 5. Specifically, the control device 55 controls the electric motor 17B of the lift device 5. Also, the control device 55 may control the electric actuator 45.

As seen from above, the lift device 5 is disposed at the center of the seat 23. Also, the electric actuator 45 and the control device 55 are disposed on opposite sides from each other with respect to the lift device 5. The electric actuator 45 is preferably joined to the rear portion of the left side member 25A of the seat frame 25. The electric actuator 45 extends upward from the left side member 25A and is disposed to the left of the seat plate 26. The upper end of the electric actuator 45 may protrude higher than the seat plate 26. The control device 55 is preferably joined to the front portion of the right side member 25A of the seat frame 25. The control device 55 is preferably disposed on the upper surface of the right side member 25A and the extension member 25D. A part of the control device 55 is disposed between the right side member 25A and the seat plate 26.

As shown in FIG. 6, the seat 23 is provided with a terminal support part 59 for holding an operation terminal for operating the mobile body 1. The operation terminal is a computer including a processor and a memory communicatively connected to the processor. The operation terminal includes a communication unit for wirelessly communicating with the control device 55, an input unit for receiving an operation performed by the occupant, and an output unit for outputting an image and a voice. The operation terminal is preferably a smartphone, for example. The control device 55 preferably controls the drive unit 2 and the lift device 5 based on the signal from the operation terminal. The terminal support part 59 is preferably provided on the seat frame 25. The terminal support part 59 includes a pillar part 59A that protrudes upward from the front end of the left or right side member 25A and a holder part 59B provided on the upper end of the pillar part 59A. The operation terminal is inserted in and held by the holder part 59B. The holder part 59B is preferably disposed higher than the seat plate 26. As seen from above, the electric actuator 45 and the terminal support part 59 are preferably disposed on opposite sides from each other about the lift device 5. In the present embodiment, the terminal support part 59 is provided at the front end of the right side member 25A.

The holding mechanism 47 is preferably disposed rearward of the electric actuator 45. The holding mechanism 47 is preferably joined to the rear portion of the left side member 25A.

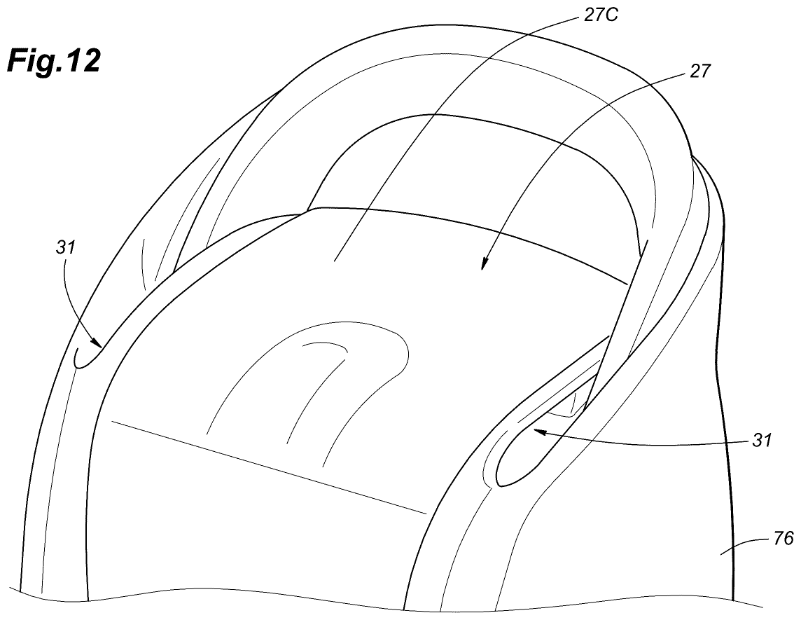

As shown in FIG. 6 to FIG. 8 and FIG. 12, at least one of the left and right side portions of the seat 23 is provided with a grip 61 to be grasped by the occupant seated on the seat 23. In the present embodiment, a pair of left and right grips 61 are joined to the front portions of the left and right side edges of the seat plate 26. The left and right grips 61 have the same structure. Each grip 61 includes a vertical wall portion 61A extending upward from the left or right side edge of the seat plate 26 and having surfaces facing in the left-right direction and an upper wall portion 61B extending laterally outward from the upper end of the vertical wall portion 61A and having surfaces facing up and down. Further, the grip 61 includes a front wall portion 61C joined to the front edges of the vertical wall portion 61A and the upper wall portion 61B and having surfaces facing forward and rearward and a rear wall portion 61D joined to the rear edges of the vertical wall portion 61A and the upper wall portion 61B and having surfaces facing forward and rearward. The upper wall portion 61B is inclined upward toward the rear. The vertical wall portion 61A, the upper wall portion 61B, the front wall portion 61C, and the rear wall portion 61D form a recess opening laterally outward.

As shown in FIG. 6, as seen from above, the left grip 61 is disposed in front of the electric actuator 45. As shown in FIG. 7, the upper end of the left grip 61 is preferably disposed higher than the upper end of the electric actuator 45. The right grip 61 is disposed above the control device 55. The rear end of the control device 55 may be disposed rearward of the rear end of the right grip 61.

As shown in FIG. 2, the pad unit 27 includes a bottom plate 27A provided on the seat plate 26 and a pad 27B having flexibility and held on the bottom plate 27A. The pad 27B is preferably covered by a skin material 27C. The edge part of the skin material 27C is preferably locked to the edge part of the bottom plate 27A. The bottom plate 27A and the pad 27B extend out laterally outward from the seat plate 26. The left edge part of the bottom plate 27A extends out to above the left grip 61 and the electric actuator 45. The right edge part of the bottom plate 27A extends out to above the right grip 61. As seen from above, the left and right grips 61, the electric actuator 45, and the control device 55 overlap the pad unit 27. Parts of the left and right side edges of the bottom plate 27A are preferably disposed along the outer side edges of the left and right grips 61. The rear portion of the pad unit 27 extends upward and covers the backrest frame 29.

Around each engagement hole 26A, a space is formed between the seat plate 26 and the bottom plate 27A. Thereby, interference of the left and right lock members 32 with the bottom plate 27A can be avoided.

As shown in FIG. 2 and FIG. 5, one of the lower unit 3 and the upper unit 4 or the upper member 16 is provided with a guide member 71, and the other of the lower unit 3 and the upper unit 4 or the upper member 16 is provided with a guide follower 72 to be guided by the guide member 71. In the present embodiment, the guide member 71 is provided on the lower unit 3, and the guide follower 72 is provided on the upper member 16. The guide member 71 is preferably provided in front of or behind the lower member 15. Also, the guide follower 72 is provided on the front portion or the rear portion of the upper member 16.

The guide member 71 is composed of a plate member. The guide member 71 is joined to the vehicle body frame 7 of the lower unit 3 so that the surfaces thereof face forward and rearward. The guide member 71 has a tapered part 73 that is widened toward the top. The tapered part 73 opens upward. The tapered part 73 is widened laterally toward the top. The tapered part 73 may include multiple tapered surfaces having different angles. For example, preferably, a first tapered surface 73A is provided in a lower portion of the tapered part 73, and a second tapered surface 73B is provided above the first tapered surface 73A. The angle of the first tapered surface 73A with respect to the vertical direction is preferably greater than the angle of the second tapered surface 73B with respect to the vertical direction. Also, the tapered part 73 may be formed to have a curved surface.

The guide member 71 includes a vertical groove part 74 that is connected to the lower end of the tapered part 73 and linearly extends downward.

The guide follower 72 includes a roller 72A that can contact the tapered part 73 and the vertical groove part 74. The roller 72A has a rotation axis extending in the front-rear direction. The guide follower 72 is smaller in size and has a lighter weight than the guide member 71.

The guide member 71 and the guide follower 72 are separated from each other when the upper unit 4 is in the high position, and guide the tilt angle of the lift device 5 to the initial angle by contacting each other when the upper unit 4 is displaced from the high position to the low position. When the upper unit 4 is in the high position, the guide follower 72 is disposed higher than the upper end of the guide member 71. When the upper unit 4 is displaced from the high position to the low position, the guide follower 72 enters the tapered part 73. At this time, if the tilt angle of the lift device 5 is relatively large, the guide follower 72 contacts the tapered part 73 and the lift device 5 is guided in the direction in which the tilt angle becomes smaller.

By the guide follower 72 entering the vertical groove part 74, the tilt angle of the lift device 5 is maintained at the initial angle. The width of the vertical groove part 74 is preferably set to be substantially the same as the width of the guide follower 72.

On the side portions of the left and right friction driving devices 8, lower cowls 75 are provided as exterior members. The upper unit 4 is provided with upper cowls 76 as exterior members. The upper cowls 76 are supported on the seat frame 25. The upper cowls 76 extend downward from the seat frame 25 and cover the lower portion of the upper unit 4 and the lift device 5. When the upper unit 4 is in the low position, the lower edges of the upper cowls 76 are disposed along the upper edges of the lower cowls 75. When the upper unit 4 is in the high position, the lower edges of the upper cowls 76 are disposed to be separated upward from the upper edges of the lower cowls 75.

Due to the guide member 71 and the guide follower 72, the lift device 5 becomes tiltable when the upper unit 4 is in the high position, and the lift device 5 becomes unable to tilt when the upper unit 4 is in the low position. Thereby, when the upper unit 4 is in the low position, interference between the lift device 5 and the lower unit 3 is avoided. Also, when the upper unit 4 is in the low position, interference between the upper cowls 76 provided on the upper unit 4 and the lower cowls 75 provided on the lower unit 3 is avoided.

Since the guide member 71 is provided on the lower unit 3, the center of gravity of the mobile body 1 can be lowered and the mobile body 1 becomes stable.

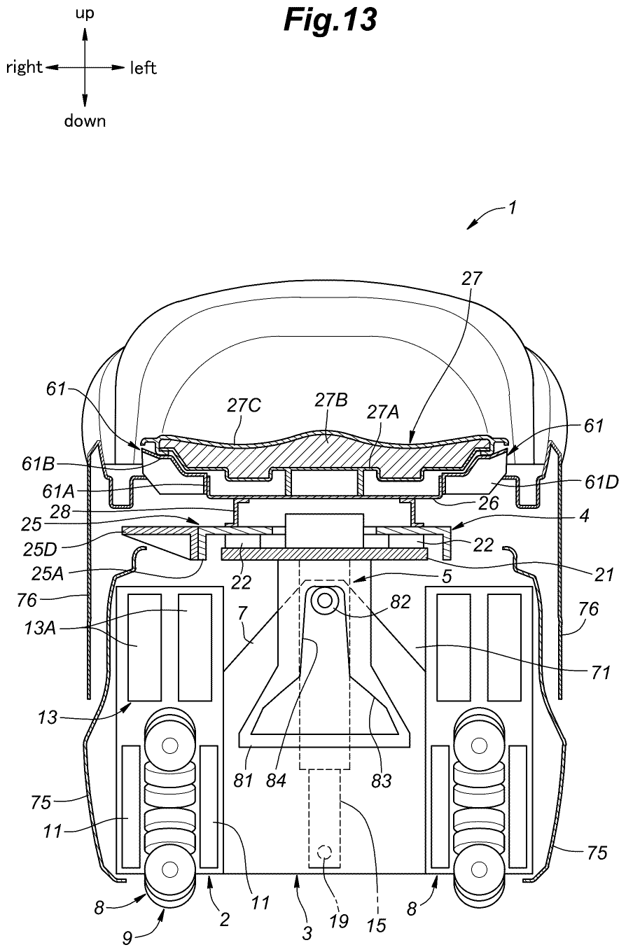

In another embodiment, as shown in FIG. 13, a guide member 81 may be provided on the upper unit 4 or the upper member 16, and a guide follower 82 may be provided on the lower unit 3. In this case, a tapered part 83 of the guide member 81 is preferably widened laterally toward the bottom. Also, the guide member 81 preferably includes a vertical groove part 84 that is connected to the upper end of the tapered part 83 and linearly extends upward. The guide follower 82 is preferably provided on the vehicle body frame 7.

The embodiment may be modified in various ways without being limited to the above-described configuration. For example, the shape, position, and number of the lock members 32, the support parts 33, the urging member 34, the pressing part 36, the intermediate member 37 which constitute the coupling mechanism 31 may be changed arbitrarily. Also, each lock member 32 may be displaced between the lock position and the release position by an electric actuator. The control device 55 preferably drives the electric actuator according to the height of the upper unit 4 to displace the lock member 32 between the lock position and the release position. In this case, the pressing part 36 and the intermediate member 37 are preferably omitted. Also, the coupling mechanism 31 may be configured to couple the base part 21 and the seat frame 25. The base part 21 may be recognized as a configuration included in the upper member 16 of the lift device 5.

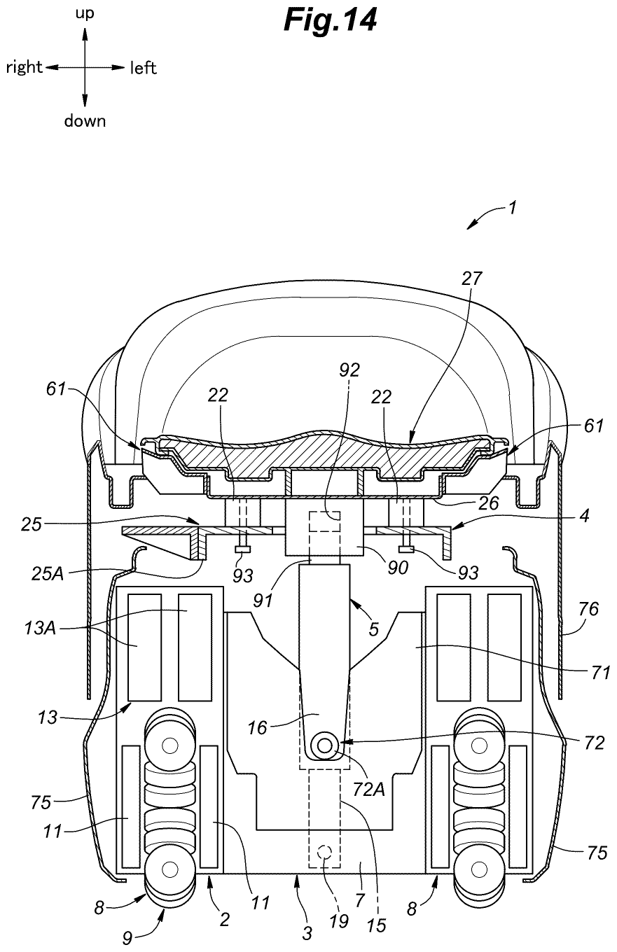

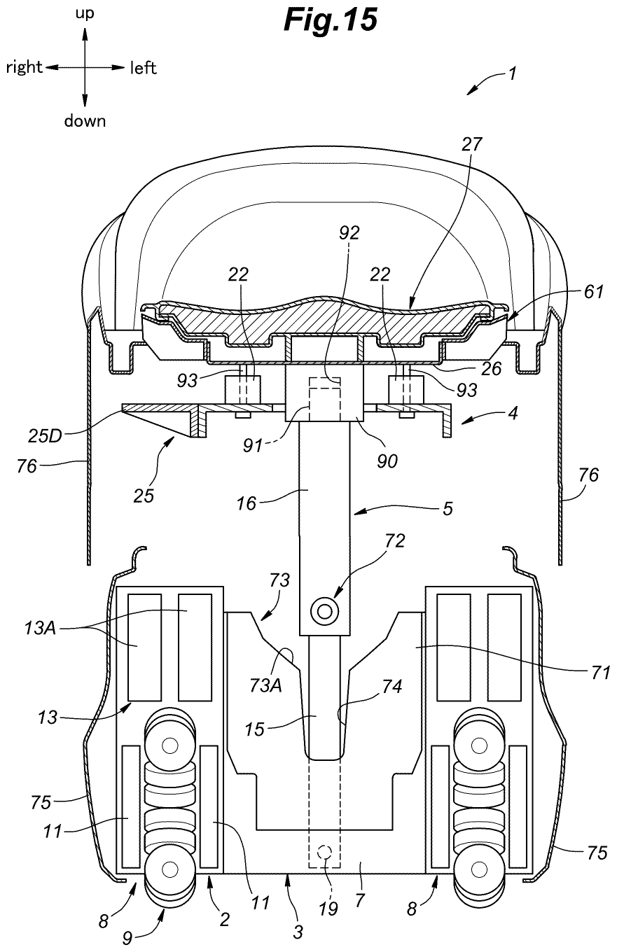

As shown in FIG. 14 and FIG. 15, in another embodiment, the lift device 5 may be connected to the seat plate 26 via a coupling member 90. In this case, the seat plate 26 is placed on the upper surface of the seat frame 25 via the elastic members 22. The upper member 16 of the lift device 5 includes a coupling shaft 91 that extends upward. The coupling member 90 is joined to the lower surface of the seat plate 26 and extends downward. Preferably, the coupling member 90 passes through an opening formed at the center of the seat frame 25 and extends downward. At the lower end of the coupling member 90, a connection hole 92 that is recessed upward is formed. The coupling shaft 91 protrudes into the connection hole 92 to be displaceable in the up-down direction and to be not displaceable in the horizontal direction.

The seat plate 26 is provided with a pair of locking parts 93. The pair of locking parts 93 extend downward from the lower surface of the seat plate 26 and pass through the elastic members 22 and the seat frame 25. Each locking part 93 is formed in a shaft shape extending vertically and has an enlarged head at the lower end thereof.

As shown in FIG. 14, when the upper unit 4 is in the low position, the multiple second leg parts 51 contact the ground, and the seat frame 25 is disposed at a predetermined height. At this time, the seat plate 26 is supported on the seat frame 25 via the elastic members 22. Also, a gap is formed between the lower end of the coupling member 90 and the upper end of the upper member 16 of the lift device 5. Further, the lower end of each locking part 93 is separated downward from the seat frame 25. Therefore, with the deformation of the elastic members 22, the seat plate 26 can be displaced in the up-down direction. Thus, the vibration from the seat frame 25 is less likely to be transmitted to the occupant seated on the seat plate 26 via the pad unit 27. The driving force of the drive unit 2 is transmitted to the seat plate 26 via the lift device 5 and is transmitted from the seat plate 26 to the seat frame 25 via the elastic members 22.

As shown in FIG. 15, when the lift device 5 is extended and the upper member 16 moves upward, the upper end of the upper member 16 comes into contact with the lower end of the coupling member 90, and the seat plate 26 is supported on the lift device 5 via the coupling member 90. Namely, the seat plate 26 is coupled to the lower unit 3 via the coupling member 90 and the lift device 5. In this state, the upper surface of the elastic member 22 and the lower surface of the seat plate 26 are separated from each other. Also, the lower end of each locking part 93 is engaged with the lower surface of the seat frame 25. Thereby, the seat frame 25 is suspended from the seat plate 26 via the locking parts 93, and the multiple second leg parts 51 are lifted off the floor surface. Namely, the coupling member 90 couples the seat plate 26 to the lift device 5 to be displaceable in the up-down direction and to be not displaceable in the horizontal direction when the upper unit 4 is in the low position, and couples the seat plate 26 to the lift device 5 to be not displaceable in the up-down direction and the horizontal direction when the upper unit 4 is in the high position.

The above embodiments may be described as follows.

One embodiment is a mobile body 1, comprising: a lower unit 3 provided with a drive unit 2; an upper unit 4 disposed above the lower unit 3; and a lift device 5 for raising and lowering the upper unit 4 relative to the lower unit 3 between a low position and a high position, wherein the upper unit 4 comprises: a base part 21 joined to the lift device 5; a seat 23 supported on the base part 21 via an elastic member 22 for supporting an occupant; and a coupling mechanism 31 that selectively couples the base part 21 and the seat 23, wherein the coupling mechanism 31 couples the base part 21 and the seat 23 so that the seat 23 cannot move relative to the base part 21 when the upper unit 4 is in the high position, and decouples the seat 23 from the base part 21 so that the seat 23 can move relative to the base part 21 when the upper unit 4 is in the low position.

According to this aspect, in the mobile body 1, when the upper unit 4 is in the high position, the base part 21 and the seat 23 can be coupled so that relative movement is prevented. Also, when the upper unit 4 is in the low position, the seat 23 becomes able to move relative to the base part 21, and the seat 23 is supported on the base part 21 via the elastic member 22. Thereby, transmission of the vibration from the road surface to the occupant seated on the seat 23 is suppressed.

In the above embodiment, the coupling mechanism 31 may include a pair of lock members 32 provided on the base part 21 to be displaceable between a release position and a lock position and capable of clamping the seat 23, and the pair of lock members 32 may be displaced from the release position to the lock position when the upper unit 4 moves from the low position to the high position.

According to this aspect, due to the pair of lock members 32 that are displaced in accordance with the ascent and descent of the upper unit 4, the seat 23 can be selectively coupled to the base part 21.

In the above embodiment, the coupling mechanism 31 may include an urging member that urges the pair of lock members 32 toward the lock position, and the pair of lock members 32 may be maintained in the release position by being pushed by a pressing part 36 provided on the lower unit 3 when the upper unit 4 is in the low position, and as the upper unit 4 is raised toward the high position, may be separated from the pressing part 36 and become able to move to the lock position.

According to this aspect, the pair of lock members 32 can be automatically displaced between the lock position and the release position in accordance with the ascent and descent of the upper unit 4.

In the above embodiment, the seat 23 may include a seat frame 25 having a frame shape, a seat plate 26 joined to the seat frame 25, and a pad 27B supported on the seat plate 26, and the seat plate 26 may have a pair of engagement holes 26A with which the pair of lock members 32 can engage.

According to this aspect, the pair of lock members 32 can be hidden below the seat 23.

In the above embodiment, the seat frame 25 may be placed on the base part 21 via an elastic member 22.

According to this aspect, the seat 23 can be provided on the base part 21 with good stability.

One embodiment is a mobile body 1, comprising: a lower unit 3 provided with a drive unit 2; an upper unit 4 disposed above the lower unit 3; and a lift device 5 for raising and lowering the upper unit 4 relative to the lower unit 3 between a low position and a high position, wherein the upper unit 4 comprises: a frame (the seat frame 25); a leg part (the second leg part 51) that extends downward from the frame (the seat frame 25) and is configured to contact a floor surface when the upper unit 4 is in the low position and to be separated from the floor surface when the upper unit 4 is in the high position; a plate (the seat plate 26) joined to an upper portion of the frame (the seat frame 25) via an elastic member 22 to support an occupant; and a coupling member 90 that couples the plate (the seat plate 26) and an upper end of the lift device 5, and wherein the coupling member 90 displaceably couples the plate (the seat plate 26) to the lift device 5 when the upper unit 4 is in the low position, and couples the plate (the seat plate 26) to the lift device 5 to be not displaceable when the upper unit 4 is in the high position.

According to this aspect, in the mobile body 1, when the upper unit 4 is in the high position, the lift device 5 and the plate (seat plate 26) can be coupled so that relative movement is prevented. Also, when the upper unit 4 is in the low position, the plate (the seat plate 26) becomes able to move relative to the frame (the seat frame 25) supported on the ground via the leg part (the second leg part 51), and the plate (the seat plate 26) is supported by the frame (the seat frame 25) via the elastic member 22. Thereby, transmission of the vibration from the road surface to the occupant seated on the plate (the seat plate 26) is suppressed.

One embodiment is a mobile body 1, comprising: a control device 55; a lower unit 3 provided with a drive unit 2 movable on a floor surface; an upper unit 4 disposed above the lower unit 3; and a lift device 5 for raising and lowering the upper unit 4 relative to the lower unit 3 between a low position and a high position, wherein the upper unit 4 comprises: a base part 21 joined to the lift device 5; a seat 23 supported on the base part 21 via an elastic member 22 to support an occupant; and a coupling mechanism 31 that selectively couples the base part 21 and the seat 23, and wherein the control device 55 is configured to conduct control to be able to switch a support state of the seat 23 on the base part 21 to a fixed state when the upper unit 4 is in the high position and to an elastic state when the upper unit 4 is in the low position.

One embodiment is a mobile body 1, comprising: a lower unit 3 provided with a drive unit 2; an upper unit 4 disposed above the lower unit 3; and a lift device 5 for raising and lowering the upper unit 4 relative to the lower unit 3 between a low position and a high position, wherein the upper unit 4 comprises: a seat 23 supported on the lift device 5; a leg part (the first leg part 41) provided to be movable in an up-down direction and capable of contacting a ground; an electric actuator 45 configured to generate a driving force for moving the leg part (the first leg part 41) in the up-down direction; and a control device 55 configured to control the lift device 5, and wherein as seen from above, the lift device 5 is disposed at a center of the seat 23, and the electric actuator 45 and the control device 55 are disposed on opposite sides from each other with respect to the lift device 5.

According to this aspect, since the electric actuator 45 for driving the leg part (the first leg part 41) and the control device 55 are disposed on opposite sides from each other with respect to the lift device 5, deviation of the position of the center of gravity of the upper unit 4 is suppressed. Thereby, in the mobile body 1, the electric actuator 45 for driving the leg part (the first leg part 41) can be disposed to achieve good balance.

In the above embodiment, the electric actuator 45 may comprise a holding mechanism 47 that holds a position of the leg part (the first leg part 41) with electric power.

According to this aspect, it is possible to hold the leg part (the first leg part 41) in a position raised upward from the floor surface.

In the above embodiment, the holding mechanism 47 may restrict displacement of the leg part (the first leg part 41) when receiving electric power, and may permit the displacement of the leg part (the first leg part 41) when not receiving electric power.

According to this aspect, when electric power supply from a power source is stopped for some reason, the leg part (the first leg part 41) can be lowered to hold the posture of the mobile body 1.

In the above embodiment, the seat 23 may be provided with a terminal support part 59 to hold an operation terminal for operating the mobile body 1, and as seen from above, the electric actuator 45 and the terminal support part 59 may be disposed on opposite sides from each other about the lift device 5.

According to this aspect, deviation of the position of the center of gravity of the upper unit 4 can be suppressed.

In the above embodiment, at least one of left and right side portions of the seat 23 may be provided with a grip 61 to be grasped by an occupant seated on the seat 23.

According to this aspect, by grasping the grip 61, the occupant can ride the mobile body 1 easily and the posture of the occupant on the mobile body becomes stable.

In the above embodiment, as seen from above, the grip 61 may be disposed in front of the electric actuator 45.

According to this aspect, deviation of the position of the center of gravity of the upper unit 4 can be suppressed.

One embodiment is a mobile body 1, comprising: a lower unit 3 provided with a drive unit 2; an upper unit 4 disposed above the lower unit 3; and a lift device 5 for raising and lowering the upper unit 4 relative to the lower unit 3 between a low position and a high position, wherein the lift device 5 comprises: a lower member 15 tiltably provided on the lower unit 3; and an upper member 16 supported to be movable up and down relative to the lower member 15 and joined to the upper unit 4, one of the lower unit 3 and the upper unit 4 or the upper member 16 is provided with a guide member 71, another of the lower unit 3 and the upper unit 4 or the upper member 16 is provided with a guide follower 72 to be guided by the guide member 71, the guide member 71 and the guide follower 72 are separated from each other when the upper unit 4 is in the high position, and guide a tilt angle of the lift device 5 relative to the lower unit 3 to an initial angle when the upper unit 4 is displaced from the high position to the low position.

According to this aspect, in the mobile body 1, the lift device 5 is allowed to tilt when the upper unit 4 is in the high position, and the lift device 5 can be made unable to tilt when the upper unit 4 is in the low position.

In the above embodiment, the guide member 71 may be provided on the lower unit 3, and the guide follower 72 may be provided on the upper unit 4 or the upper member 16.

According to this aspect, the center of gravity of the mobile body 1 can be lowered and the mobile body 1 becomes stable. The guide member 71 is easier to become large and heavy than the guide follower 72.

In the above embodiment, the guide member 71 may have a tapered part 73 that is widened toward a top, and the guide follower 72 may include a roller 72A that can contact the tapered part 73.

According to this aspect, the movement of the guide follower 72 relative to the guide member 71 can be made smooth.

In the above embodiment, the guide member 71 may include a vertical groove part 74 that is connected to a lower end of the tapered part 73 and linearly extends downward, and the tilt angle of the lift device 5 may be maintained at the initial angle by the guide follower 72 entering the vertical groove part 74.

According to this aspect, when the upper unit 4 approaches the low position, the tilt angle is maintained at the initial angle.

In the above embodiment, the tapered part 73 may include multiple tapered surfaces having different angles.

According to this aspect, the movement of the guide follower 72 relative to the guide member 71 can be made smooth.

In the above embodiment, the guide follower 72 may be provided on the upper member 16.

According to this aspect, the guide follower 72 can be disposed closer to the guide member 71, whereby the guide member 71 can be made smaller.

In the above embodiment, the guide member 71 may be provided in front of or behind the lower member 15, and the guide follower 72 may be provided on a front portion or a rear portion of the upper member 16.

In the above embodiment, the guide member 81 may be provided on the upper unit 4 or the upper member 16, and the guide follower 82 may be provided on the lower unit 3.

1. A mobile body, comprising:
a lower unit provided with a drive unit;
an upper unit disposed above the lower unit; and
a lift device for raising and lowering the upper unit relative to the lower unit between a low position and a high position,
wherein the upper unit comprises:
a seat supported on the lift device;
a leg part provided to be movable in an up-down direction and capable of contacting a ground;
an electric actuator configured to generate a driving force for moving the leg part in the up-down direction; and
a control device configured to control the lift device,
and wherein as seen from above, the lift device is disposed at a center of the seat, and the electric actuator and the control device are disposed on opposite sides from each other with respect to the lift device.

2. The mobile body according to claim 1, wherein the electric actuator comprises a holding mechanism that holds a position of the leg part with electric power.

3. The mobile body according to claim 2, wherein the holding mechanism restricts displacement of the leg part when receiving electric power, and permits the displacement of the leg part when not receiving electric power.

4. The mobile body according to claim 1, wherein the seat is provided with a terminal support part to hold an operation terminal for operating the mobile body, and
as seen from above, the electric actuator and the terminal support part are disposed on opposite sides from each other about the lift device.

5. The mobile body according to claim 1, wherein at least one of left and right side portions of the seat is provided with a grip to be grasped by an occupant seated on the seat.

6. The mobile body according to claim 5, wherein as seen from above, the grip is disposed in front of the electric actuator.
